(19) United States
(12) Patent Application Publication
(10) Pub. No.: US 2009/0243166 A1
(43) Pub. Date: Oct. 1, 2009

(54) METHOD FOR MANUFACTURING HONEYCOMB STRUCTURE

(75) Inventors: Yasushi NOGUCHI, Nagoya-city (JP); Yukari NAKANE, Nagoya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/397,920

(22) Filed: Mar. 4, 2009

(30) Foreign Application Priority Data
Mar. 28, 2008 (JP) 2008-088186

(51) Int. Cl. C04B 35/64

(52) U.S. Cl. 264/631; 264/630

(57) ABSTRACT

There is provided a method for manufacturing a honeycomb structure capable of inhibiting a cut due to drying or firing from generating upon manufacturing a large-sized honeycomb structure. The method for manufacturing a honeycomb structure comprises the steps of: forming kneaded clay containing 3 to 6 parts by mass of a water-absorbent resin having a water-absorption ratio of 10 to 20 times with respect to 100 parts by mass of an oxide ceramic-forming raw material into a honeycomb shape to obtain a honeycomb formed article, drying the honeycomb formed article to obtain a honeycomb dried article, and firing the honeycomb dried article to obtain a honeycomb structure having a volume of 15 to 30 liter and a porosity of 55 to 70%.

### BACKGROUND OF THE INVENTION AND RELATED ART STATEMENT

The present invention relates to a method for manufacturing a honeycomb structure. More specifically, the present invention relates to a method for manufacturing a honeycomb structure, the method being capable of inhibiting a cut due to drying or firing from generating upon manufacturing a large-sized honeycomb structure.

In order to adsorb and purify NOx, CO, HC and the like contained in automobile exhaust gas by a loaded catalyst or the like and further in order to trap and remove particulate matter in the exhaust gas, there is used a honeycomb structure of an oxide ceramic such as cordierite having low thermal expansion coefficient. As such a honeycomb structure, a honeycomb structure having pores in the partition walls are generally used in order to load a catalyst or the like and further in order to trap particulate matter in exhaust gas. As a method for forming the pores, there is a method where a pore former having solid-core particles or hollow particles is blended into the forming raw material and where the pore former is burnt away upon firing the formed article to form pores. In addition, there is disclosed a method using a water-absorbent resin as a pore former (see, e.g., JP-A-2004-262747 and WO2005/063360 pamphlet).

In the case of using the solid-core particles as the pore former, since the particles have a solid core, the particles hardly crash upon mixing and kneading the forming raw material, and stable porosity can be obtained. However, there are problems of clogging of the particles in the extrusion die to cause a defect such as chipping of rib and increase in extrusion pressure to cause deformation in the extrusion die. Further, there is a problem of high heat generation amount upon firing the particles to cause defectives such as a crack and an internal defect. On the other hand, in the case of using hollow particles as the pore former, generation of the aforementioned defects can be suppressed because of low heat generation amount upon firing since the particles are hollow. However, since particles easily crash upon mixing, kneading, or forming the forming raw material, stable porosity cannot be secured, and a problem of deterioration in filter properties arises. As a method for inhibiting particles from crashing, there is a method where hardness of the kneaded clay is decreased. However, there is a problem of deformation of a formed article.

JP-A-2004-262747 described above discloses a method where a forming raw material containing a water-absorbent resin blended as a pore former is subjected to extrusion forming to obtain a formed article, followed by firing the formed article to obtain porous ceramic. According to this method, since a water-absorbent resin is used as a pore former, crash of the pore former due to pressure or shearing force in a manufacturing process is hardly generated. Therefore, it is not necessary to decrease hardness of the kneaded clay, and deformation of a formed article can be suppressed in the manufacturing process. Since the pore former does not crash, a pore-forming function is not lost. Therefore, porosity can be made stable. However, in the case of forming an oxide ceramic honeycomb structure having a volume of 15 liter or more by this method, there is a problem of causing a crack (cut) in the partition walls upon drying or firing.

WO2005/063360 described above discloses a method for manufacturing a honeycomb structure by forming kneaded clay obtained by mixing and kneading a ceramic raw material, a water-absorbent resin, and the like into a honeycomb structure, followed by drying and firing. According to this method, since plasticity of the kneaded clay can be improved by the water-absorbent resin, thereby improving formability of the kneaded clay, a defect or a deformation upon forming can be suppressed, and yield can be improved. However, in the case of manufacturing an oxide ceramic honeycomb structure having a volume of 15 liter or more, there is a problem of causing a crack (cut) in the partition walls upon drying or firing also in this method.

### SUMMARY OF THE INVENTION

The present invention has been made in view of such prior art problems and is characterized by providing a method for manufacturing a honeycomb structure capable of inhibiting a cut due to drying or firing from generating upon manufacturing a large-sized honeycomb structure.

According to the present invention, there is provided the following method for manufacturing honeycomb structure.

[1] A method for manufacturing a honeycomb structure, the method comprising the steps of:

forming kneaded clay containing 3 to 6 parts by mass of a water-absorbent resin having a water-absorption ratio of 10 to 20 times with respect to 100 parts by mass of an oxide ceramic-forming raw material into a honeycomb shape to obtain a honeycomb formed article, drying the honeycomb formed article to obtain a honeycomb dried article, and firing the honeycomb dried article to obtain a honeycomb structure having a volume of 15 to 30 liter and a porosity of 55 to 70%.

[2] A method for manufacturing a honeycomb structure according to [1], wherein the water-absorbent resin has an average particle diameter of 5 to 40 μm after absorbing water.

[3] A method for manufacturing a honeycomb structure according to [1] or [2], wherein a honeycomb dried article is manufactured by subjecting the honeycomb formed article to dielectric drying.

[4] A method for manufacturing a honeycomb structure according to any one of [1] to [3], wherein the oxide ceramic-forming raw material is a cordierite-forming raw material.

According to a method for manufacturing a honeycomb structure of the present invention, since the water-absorbent resin as a pore former contained in the kneaded clay has a water-absorption ratio of 20 times or less, water retention force of the water-absorbent resin can be controlled lest the force should be too strong. This enables to suppress drying unevenness of the honeycomb dried article and to suppress a cut in a partition wall upon manufacturing a honeycomb structure having a volume of 15 to 30 liter. Incidentally, the “volume” means a volume determined by the outer shape of a structure including the partition wall portion and the gas flow passages of the honeycomb structure. In addition, since the water-absorbent resin has the water-absorption ratio of 10 times or more, water can be absorbed sufficiently enough to maintain high pore formability. Therefore, the amount of the water-absorbent resin can be maintained low, and a honeycomb structure can be manufactured at low costs without spending extra time upon combusting and removing the water-absorbent resin. In additions since the kneaded clay contains 3 to 6 parts by mass of a water-absorbent resin with respect to 100 parts by mass of an oxide ceramic-forming raw material, a honeycomb structure having a porosity of 55 to 70% can be obtained.

### DETAILED DESCRIPTION OF THE INVENTION

Hereinbelow, the best embodiment for carrying out the present invention will specifically be described. However, the present invention is by no means limited to the following embodiment, and it should be understood that changes, improvements, and the like of the design may appropriately be made on the basis of ordinary knowledge of a person of ordinary skill in a range without deviating from the gist of the present invention.

An embodiment of a method for manufacturing a honeycomb structure of the present invention includes the steps of: forming kneaded clay containing 3 to 6 parts by mass of a water-absorbent resin having a water-absorption ratio of 10 to 20 times with respect to 100 parts by mass of an oxide ceramic-forming raw material into a honeycomb shape to obtain a honeycomb formed article, drying the honeycomb formed article to obtain a honeycomb dried article, and firing the honeycomb dried article to obtain a honeycomb structure having a volume of 15 to 30 liter and a porosity of 55 to 70%. Here, the honeycomb structure is a cylindrical structure having porous partition walls separating and forming a plurality of cells. In addition, the content of the water-absorbent resin in the kneaded clay is expressed by mass of the dried water-absorbent resin.

### (Kneaded Clay)

As an embodiment of a method for manufacturing a honeycomb structure of the present invention, in the first place, kneaded clay is formed by mixing and kneading an oxide ceramic-forming raw material, water, and a water-absorbent resin. At this time, it is preferable to mixing and kneading the materials with adding a binder, a surfactant, and the like thereto. The oxide ceramic-forming raw material is a raw material which becomes oxide ceramic by firing and is preferably a cordierite-forming raw material, an aluminum titanate-forming raw material, or the like. The cordierite-forming raw material means a raw material which becomes cordierite by firing and is a ceramic raw material where predetermined raw materials are mixed together to give a chemical composition containing 42 to 56 mass % of silica (SiO₂), 30 to 45 mass % of alumina (Al₂O₃), and 12 to 16 mass % of magnesia (MgO). The “predetermined raw materials” to be mixed includes talc, kaolin, alumina source raw material, silica, and the like. Incidentally, the alumina source raw material means a raw material which becomes an oxide by firing and forms a part of cordierite, such as aluminum oxide, aluminum hydroxide, and boehmite. The aluminum titanate-forming raw material means a raw material which becomes aluminum titanate by firing and is a ceramic raw material where predetermined raw materials are mixed together to give a chemical composition containing 53 to 74 mass % of alumina (Al₂O₃), 14 to 33 mass % of titanium (TiO₂), and 6 to 20 mass % of silica (SiO₂).

The aforementioned water-absorbent resin has a water-absorption ratio of 10 to 20 times, preferably 12 to 20 times, and more preferably 15 to 20 times. Since the water-absorbent resin has a water-absorption ratio of 20 times or less, water retention force of the water-absorbent resin can be controlled lest the force should be too strong. This enables to suppress drying unevenness of the honeycomb dried article and to suppress a cut in a partition wall upon manufacturing a honeycomb structure having a volume of 15 to 30 liter. In addition, since the water-absorbent resin has the water-absorption ratio of 10 times or more, water can be absorbed sufficiently enough to maintain high pore formability. Therefore, the amount of the water-absorbent resin can be maintained low, and a honeycomb structure can be manufactured at low costs without spending extra time upon combusting and removing the water-absorbent resin. When the water-absorption ratio is below 10 times, pore formability is deteriorated because the water amount to be absorbed is small. Since this needs increase in the additive amount, time taken for combusting and removing the water-absorbent resin becomes long, and costs are increased because the additive amount is increased. In the case that high porosity counts depending on the use, the ratio is desirably 12 times or more, more desirably 15 times or more. When the water-absorption ratio is above 20 times, water retention force of the water-absorbent resin becomes too strong, and water is left inside the honeycomb dried article even after drying to cause drying unevenness in the honeycomb dried article, thereby causing a cut in a partition wall. When drying unevenness is caused in the honeycomb dried article, a local difference in shrinkage is caused inside the dried article, and thereby a cut is caused in a partition wall. Here, the “water-absorption ratio” means the ratio (multiple number) of a “mass of absorbed purified water” to a “mass of dried water-absorbent resin”. For example, when the amount of the “dried water-absorbent resin” is 1 part by mass, and the amount of the “absorbed purified water” is 3 parts by mass, the water-absorption ratio is 3 times.

The water-absorbent resin has an average particle diameter of preferably 5 to 40 μm, more preferably 10 to 40 μm, after absorbing water. When the average particle diameter of the water-absorbent resin after absorbing water is smaller than 5 μm, clogged pores extremely increase in the case that a catalyst is loaded because pores of the honeycomb structure are small, and pressure loss may be increased. When the average particle diameter is larger than 40 μm, pores having large diameters increase, and therefore soot trapping efficiency and strength of the honeycomb structure may be deteriorated. When the particle diameter is too large, a cut may easily be caused in a partition wall, and clogging may easily be caused when a slit of an extrusion die is narrow. The average particle diameter of the water-absorbent resin after absorbing water is preferably 40% or less, more preferably, 30% or less, furthermore preferably 25% or less, of the partition wall thickness of the honeycomb structure obtained. Setting the average particle diameter of the water-absorbent resin after absorbing water 40% or less of the partition wall thickness of the honeycomb structure can suppress generation of a cut in a partition wall of the honeycomb structure more effectively and contribute to securement of strength of the honeycomb structure. When it is above 40%, a cut may easily be caused in a partition wall of the honeycomb structure, and strength may become insufficient because coarse pores with respect to the partition wall thickness may easily be formed after the honeycomb formed article is fired.

As described above, when the average particle diameter of the water-absorbent resin after absorbing water becomes large with respect to the slit of the extrusion die, the die may cause clogging. However, since the particles pass through the slit or a screen for inhibiting coarse particles from mixing by the self-transformation due to elastic force exhibited by absorbing water in comparison with the other resins, clogging in the extrusion die is less caused. In addition, since heat generation amount upon firing is small, defectives such as crack generation can be reduced. Further, since the particles do not crush even by being subjected to share load without impairing pore formability, fluctuations in porosity can be suppressed, and stable porosity can be secured.

As the water-absorbent resin, there can specifically be used a water-absorbent resin of starch type, polyacrylic acid type, polyvinyl alcohol type, cellulose type, synthetic polymer type, or the like. In particular, since a polyacrylic type water-absorbent resin has high water-absorption rate, water can be absorbed in a short period of time, time-dependent change of kneaded clay properties after mixing and kneading is hardly caused.

The content of the water-absorbent resin in the kneaded clay is preferably 3 to 6 parts by mass with respect to 100 parts by mass of an oxide ceramic-forming raw material. The content of the water-absorbent resin in the kneaded clay within such a range enables to obtain a honeycomb structure having a porosity of 55% or more and to further improve formability of the honeycomb formed article. When the content (additive amount) of the water-absorbent resin is below 3 parts by mass with respect to 100 parts by mass of total mass of an oxide ceramic-forming raw material, the porosity of the honeycomb structure cannot be 55% or less. When the content is above 6 parts by mass, since the required water amount increases, long time drying is required, thereby raising costs. Incidentally, since the plasticity of the kneaded clay is raised when the water-absorbent resin is contained in the kneaded clay, formability of the honeycomb formed article is improved. That is, water retentivity of the kneaded clay is enhanced to improve lubricity upon extrusion forming.

In a method for manufacturing a honeycomb structure of the present embodiment, examples of the binder contained in the kneaded clay include methyl cellulose, hydroxypropylmethyl cellulose, hydroxyethyl cellulose, carboxylmethyl cellulose, and polyvinyl alcohol. These may be used alone or in combination of two or more kinds.

In a method for manufacturing a honeycomb structure of the present embodiment, the surfactant contained in the kneaded clay may be an anion type, a cation type, a nonion type, or a mixed anion and cation type. Examples of the anion surfactant include fatty acid salt, alkylsulfate, polyoxyethylene alkyl ether sulfate, polycarboxylate, and polyacrylate. In addition, examples of the nonion surfactant include polyoxyethylene alkyl ether, polyoxyethylene glycerin fatty acid ester, and polyoxyethylene sorbitan (or sorbitol) fatty acid ester. The surfactant improves dispersibility of raw material particles and makes orientation of the raw material particles easier in the extrusion forming step.

In a method for manufacturing a honeycomb structure of the present embodiment, water is contained in the kneaded clay as a dispersion medium. The water content in the kneaded clay is preferably the content where the kneaded clay has an appropriate hardness upon extrusion forming of a honeycomb formed article, and the content is preferably parts by mass or more of the value obtained by multiplying the amount of the water-absorbent resin by half the water-absorption ratio (mixed amount of water-absorbent resin times half the water-absorption ratio) with respect to 100 parts by mass of the oxide ceramic-forming raw material including water in the water-absorbent resin.

In a method for manufacturing a honeycomb structure of the present embodiment, there is no particular limitation on a method for mixing the cordierite-forming raw material, the binder, the surfactant, water, and the water-absorbent resin, and a known method, for example, premixing maybe employed. In particular, the water-absorbent resin may be mixed with the other raw materials after water is absorbed in advance (water may be absorbed up to a predetermined extent or up to the water-absorption ratio), or the water-absorbent resin in the dried state may be mixed with the other raw materials to absorb water. The latter method is more suitable in that the process is simple. There is no particular limitation on the method for obtaining the kneaded clay by kneading the mixture, and a known method may be employed. The kneading may be performed by the use of, for example, a kneader or a vacuum kneader.

(Forming)

Next, the kneaded clay is formed into a honeycomb shape to obtain a honeycomb formed article. It is preferable to manufacture the honeycomb formed article by subjecting the kneaded clay to extrusion forming using a die having a desired cell shape, partition wall thickness, cell density, and the like and a screen having an opening in accordance with the die. It is preferable that extrusion pressure is not remarkably raised in order to inhibit the extrusion die from being deformed. It is preferable to manufacture the honeycomb formed article in such a manner that a honeycomb structure under the conditions described later can be obtained when the honeycomb formed article is fired.

(Drying)

Next, the honeycomb formed article obtained above is dried to obtain a honeycomb dried article. There is no particular limitation on the drying method, and a known method, for example, hot air drying, microwave drying, dielectric drying, decompression drying, vacuum drying, and freeze drying may be employed alone or in combination. Of these, dielectric drying is preferable in that the whole formed article can be dried quickly and uniformly.

(Calcination)

Next, it is preferable that the honeycomb dried article obtained above is calcined before firing. The “calcination” means an operation of combusting and removing organic matter (binder, water-absorbent resin, etc.) in the honeycomb dried article. Since the firing temperatures of the binder (organic binder) and the water-absorbent resin are generally about 100 to 300° C. and about 200 to 800° C., respectively, the calcination temperature may be set to about 200 to 1000° C. Though the calcination time is not particularly limited, it is generally about 10 to 100 hours.

(Firing)

Next, the honeycomb dried article is fired to obtain a honeycomb structure. By the firing, the ceramic raw material in the honeycomb dried article is sintered for densification, and predetermined strength can be secured. As the firing conditions (temperature, time) when the oxide ceramic-forming raw material is a cordierite-forming raw material, firing is preferably performed at 1350 to 1440° C. for about 3 to 20 hours. As the firing conditions (temperature, time) when the oxide ceramic-forming raw material is an aluminum titanate-forming raw material, firing is preferably performed at 1550 to 1700° C. for about 2 to 15 hours. It is preferable to perform the aforementioned calcination and the firing continuously in the viewpoint of time efficiency and energy efficiency.

It is more preferable that the honeycomb structure manufactured in a method for manufacturing a honeycomb structure of the present embodiment has the partition walls having a porosity of 55 to 70%. Because the porosity of the partition walls of the honeycomb structure is high in this range, pressure loss when a fluid to be treated passes can be maintained at low level with maintaining strength of the honeycomb structure at high level. When the porosity of the partition walls is below 55%, it is not preferable because pressure loss when a fluid to be treated passes is large. When the porosity of the partition walls is above 70%, it is not preferable because strength of the honeycomb structure is low. Incidentally, the porosity is calculated using absolute specific gravity of the oxide ceramic such as cordierite by measuring the whole pore capacity with a mercury porosimeter. The porosity of the partition walls can be controlled to the aforementioned predetermined value by adjusting mainly the additive amount of the water-absorbent resin in the kneaded clay to 3 to 6 parts by mass with respect to 100 parts by mass of total mass of an oxide ceramic-forming raw material.

The volume of the honeycomb structure manufactured in a method for manufacturing a honeycomb structure of the present embodiment is preferably 30 liter or less, more preferably 15 to 30 liter. Since a cut is easily caused in a partition wall particularly when a water-absorbent resin is used as a pore former in a honeycomb structure having a volume in such a range, it is preferable to apply a method for manufacturing a honeycomb structure of the present embodiment to the manufacture of a honeycomb structure having such a size. In the relation with the aforementioned water-absorption ratio, by satisfying 0≦(water-absorption ratio−10)/volume≦0.6, an effect of inhibiting a dry cut can be improved. It is more preferable to satisfy 0≦(water-absorption ratio−10)/volume≦0.4. The shape of the honeycomb structure is not particularly limited, and, a shape of, for example, a cylinder, a quadrangular prism, a triangular prism, another prism, or the like may be employed.

In addition, there is no particular limitation on the cell shape of a honeycomb structure (cell shape in a cross section perpendicular to a direction where the central axis of the honeycomb filter extends (a direction where the cells extend)), and, a shape of, for example, a rectangle, a hexagon, a triangle, or the like may be employed. It is not necessary to employ a single cell shape in the honeycomb structure, and it is also preferable to employ a combination of, for example, rectangular cells and hexagonal cells.

The honeycomb structure has the partition walls having an average pore diameter of preferably 5 to 40 μm, more preferably 10 to 30 μm. When the number of pores having small pore diameters is too high, the number of pores clogged when a catalyst is loaded becomes too high, and therefore pressure loss may be increased. When the number of pores having large pore diameters is too high, the soot trapping efficiency and the strength of the honeycomb structure maybe deteriorated. The average pore diameter is a value of the median pore diameter on the volumetric basis by a mercury porosimeter.

Though there is no particular limitation on the cell density of the honeycomb structure obtained, it is preferably 20 to 160 cells/cm², more preferably 40 to 120 cells/cm².

When the honeycomb structure is used as a catalyst-carrying substrate, the honeycomb structure can suitably be used by loading a catalyst on the partition walls. Examples of the catalyst to be loaded include a ternary catalyst, an oxidation catalyst, a NOₓ trapping catalyst, and a SCR catalyst. On the other hand, when the honeycomb structure is used as a soot trapping filter, it is also preferable to subject the end faces to plugging. It is preferable to perform plugging alternately on both the end faces in such a manner that both the end faces show a checkerwise pattern. Further, a catalyst may be loaded on the partition walls of the filter.

### EXAMPLE

Hereinbelow, the present invention will be described more specifically by Examples. However, the present invention is by no means limited to these Examples.

### Example 1

There was used, as a cordierite-forming raw material (Cd), a mixture containing 41 mass % of talc, 19 mass % of kaolin, 25 mass % of aluminum oxide, and 15 mass % of silica. To 100 parts by mass of the cordierite-forming raw material were added 62 parts by mass (water ratio) of water as a dispersion medium and 4 parts by mass of methyl cellulose as a binder, and a water-absorbent resin in a dry state was added in such a manner that the ratio of the water-absorbent resin to 100 parts by mass of the total cordierite-forming raw material is 4 parts by mass. They were mixed and kneaded to prepare kneaded clay. As the water-absorbent resin, there was used a resin having a water-absorption ratio of 10.5 times and an average particle diameter (average particle diameter after absorbing water) of 32 μm after absorbing water. Mixing and kneading were performed with a sigma kneader, and kneading was further performed with a vacuum kneader to obtain kneaded clay extruded to have a cylindrical shape (bottom face diameter of 300 mm).

The kneaded clay was subjected to extrusion forming using a ram extruder to manufacture a honeycomb formed article having a rectangular cell cross-sectional shape and a cylindrical whole shape.

Next, the honeycomb formed article was dried by dielectric drying to obtain a honeycomb dried article.

Then, the honeycomb dried article was fired to obtain a honeycomb structure. As a firing condition, the highest temperature was within the range from 1350 to 1440° C.

The honeycomb structure had a cylindrical shape (volume of 26.1 liter (L)) having a diameter of 330 mm and a length (height) in the axial direction of 305 mm with a partition wall thickness of 305 μm, a cell density of 47 cells/cm² (12 mil/300 cpsi), and a partition wall porosity of 55%. The porosity was calculated from the whole pore capacity measured by an automatic porosimeter, Micromeritics Autopore 9500, produced by Shimadzu Corporation. At this time, the absolute specific gravity of the cordierite was set to 2.52.

By the above method, 14 honeycomb structures were manufactured. A “cut in a partition wall” in each of the honeycomb structures was checked by the method described below. The results are shown in Table 1.

(Cut in Partition Wall)

The partition walls were visually observed from the end faces of each honeycomb structure to recognize a honeycomb structure having “no” cut as an “acceptable” honeycomb structure with evaluating a honeycomb structure with no cut as “absent” and a honeycomb structure having a cut as “present”. The ratio of the number of the acceptable honeycomb structure to the number of the honeycomb structure manufactured was determined as the “yield”. Table 1 shows the “number of acceptable” honeycomb structure and the “yield” as the evaluation results of a “cut in a partition wall”.

TABLE 1

| | | Water-absorbent resin | | | | | | | | | | |
|---|---|---|---|---|---|---|---|---|---|---|---|---|
| | | | | Average | | | | | | | | |
| | | | | particle | | | | | | | | |
| | | | | diameter | Water | | | | | | | |
| | | Additive | Water- | after | ratio | Honeycomb structure | | | | | Number | |
| | | amount | absorption | absorbing | (parts | | Size | | | Number | of | |
| | Raw | (parts | ratio | water | by | Porosity | Diameter | Height | Volume | of dried | acceptable | Yield |
| | material | by mass) | (times) | (μm) | mass) | (%) | (mm) | (mm) | (L) | articles | article | (%) |
| Example 1 | Cd | 4 | 10.5 | 32 | 62 | 55 | 330 | 305 | 26.1 | 7 | 7 | 100.0 |
| Example 2 | Cd | 4 | 16.5 | 32 | 67 | 59 | 330 | 305 | 26.1 | 7 | 7 | 100.0 |
| Example 3 | Cd | 4 | 19.5 | 32 | 69 | 62 | 330 | 305 | 26.1 | 21 | 18 | 85.7 |
| Example 4 | Cd | 4 | 19.5 | 32 | 69 | 62 | 267 | 305 | 17.0 | 7 | 6 | 85.7 |
| Example 5 | Cd | 4 | 20.0 | 32 | 69 | 62 | 330 | 305 | 26.1 | 27 | 19 | 70.4 |
| Example 6 | Cd | 3 | 19.5 | 32 | 60 | 58 | 330 | 305 | 26.1 | 15 | 10 | 66.7 |
| Example 7 | Cd | 6 | 16.5 | 32 | 82 | 69 | 267 | 305 | 17.0 | 5 | 3 | 60.0 |
| Example 8 | Cd | 4 | 19.5 | 9 | 69 | 58 | 330 | 305 | 26.1 | 6 | 4 | 66.7 |
| Example 9 | AT | 5 | 20.0 | 32 | 45 | 59 | 330 | 305 | 26.1 | 5 | 5 | 100.0 |
| Example 10 | AT | 5 | 16.5 | 32 | 45 | 58 | 330 | 305 | 26.1 | 5 | 5 | 100.0 |
| Comp. Ex. 1 | Cd | 4 | 20.5 | 17 | 69 | 61 | 330 | 305 | 26.1 | 11 | 0 | 0.0 |
| Comp. Ex. 2 | Cd | 4 | 22.9 | 32 | 69 | 62 | 330 | 305 | 26.1 | 10 | 0 | 0.0 |
| Comp. Ex. 3 | Cd | 4 | 22.9 | 32 | 69 | 62 | 267 | 305 | 17.0 | 8 | 0 | 0.0 |
| Ref. Ex. 1 | Cd | 4 | 9.0 | 32 | 56 | 52 | 330 | 305 | 26.1 | 5 | 5 | 100.0 |
| Ref. Ex. 2 | Cd | 2 | 20.0 | 32 | 51 | 54 | 330 | 305 | 26.1 | 12 | 12 | 100.0 |
| Ref. Ex. 3 | Cd | 2 | 20.5 | 17 | 51 | 54 | 330 | 305 | 26.1 | 6 | 6 | 100.0 |
| Ref. Ex. 4 | Cd | 2 | 22.9 | 32 | 51 | 54 | 330 | 305 | 26.1 | 5 | 5 | 100.0 |
| Ref. Ex. 5 | Cd | 7 | 16.5 | 32 | 89 | 72 | 267 | 305 | 17.0 | 5 | 0 | 0.0 |
| Ref. Ex. 6 | Cd | 4 | 22.9 | 32 | 69 | 62 | 229 | 283 | 11.7 | 5 | 5 | 100.0 |

### Examples 2 to 8

The honeycomb structures were manufactured in the same manner as in Example 1 except that the additive amounts of the water-absorbent resins were as shown in Table 1 by using water-absorbent resins having the water-absorption ratios and the average particle diameters after absorbing water shown in Table 1, that the porosities and sizes of the honeycomb structures were adjusted as shown in Table 1, and that the numbers of the honeycomb structures manufactured were as shown in Table 1.

A “cut in a partition wall” in each of the honeycomb structures was checked by the method described above. The results are shown in Table 1.

### Examples 9 and 10

The honeycomb structures were manufactured in the same manner as in Example 1 except that aluminum titanate-forming raw material (AT) was used as the oxide ceramic-forming raw material, that the additive amounts of the water-absorbent resins were as shown in Table 1 by using water-absorbent resins having the water-absorption ratios and the average particle diameters after absorbing water, shown in Table 1, that the porosities of the honeycomb structures were adjusted as shown in Table 1, and that the numbers of the honeycomb structures manufactured were as shown in Table 1.

A “cut in a partition wall” in each of the honeycomb structures was checked by the method described above. The results are shown in Table 1.

### Comparative Examples 1 to 3

The honeycomb structures were manufactured in the same manner as in Example 1 except that the additive amounts of the water-absorbent resins were as shown in Table 1 by using water-absorbent resins having the water-absorption ratios and the average particle diameters after absorbing water, shown in Table 1, that the porosities of the honeycomb structures were adjusted as shown in Table 1, and that the numbers of the honeycomb structures manufactured were as shown in Table 1.

A “cut in a partition wall” in each of the honeycomb structures was checked by the method described above. The results are shown in Table 1.

### Reference Examples 1 to 6

The honeycomb structures were manufactured in the same manner as in Example 1 except that the additive amounts of the water-absorbent resins were as shown in Table 1 by using water-absorbent resins having the water-absorption ratios and the average particle diameters after absorbing water, shown in Table 1, that the porosities of the honeycomb structures were adjusted as shown in Table 1, and that the numbers of the honeycomb structures manufactured were as shown in Table 1.

A “cut in a partition wall” in each of the honeycomb structures was checked by the method described above. The results are shown in Table 1.

From Table 1, by methods for manufacturing honeycomb structures of Examples 1 to 10, large-sized honeycomb structures each having high porosity can be manufactured at high yield. In contrast, it can be understood that, by the methods for manufacturing honeycomb structures of Comparative Examples 1 to 3, since the water-absorbent resins have high water-absorbing ratios, a cut was caused in all the honeycomb structures obtained to show low yields. It can also be understood that, as the method for manufacturing a honeycomb structure in Reference Example 1, a honeycomb structure having high porosity cannot be obtained when the water-absorbent resin has low water-absorption ratio. It can be understood that, in the method for manufacturing honeycomb structures of Reference Examples 2 to 4, porosities of the honeycomb structures are low because the additive amounts of the water-absorbent resins are small, and therefore a honeycomb structure having high porosity cannot be obtained. In the method for manufacturing a honeycomb structure of Reference Example 5, it can be understood that porosity is high because the additive amount of the water-absorbent resin is large. Incidentally, it can be understood that, as shown in Reference Example 6, in the case that a honeycomb structure to be manufactured is so small as 11.7 L, a cut is not caused even if the water-absorbent resin has too high water-absorption ratio.

A method for manufacturing a honeycomb structure of the present invention can be used for manufacturing a honeycomb structure used for adsorbing and purifying NOx, CO, HC and the like contained in automobile exhaust gas by a loaded catalyst or the like and for trapping and removing particulate matter in the exhaust gas.

What is claimed is:

1. A method for manufacturing a honeycomb structure, the method comprising the steps of:
forming kneaded clay containing 3 to 6 parts by mass of a water-absorbent resin having a water-absorption ratio of 10 to 20 times with respect to 100 parts by mass of an oxide ceramic-forming raw material into a honeycomb shape to obtain a honeycomb formed article,
drying the honeycomb formed article to obtain a honeycomb dried article, and
firing the honeycomb dried article to obtain a honeycomb structure having a volume of 15 to 30 liter and a porosity of 55 to 70%.

2. A method for manufacturing a honeycomb structure according to claim 1, wherein the water-absorbent resin has an average particle diameter of 5 to 40 μm after absorbing water.

3. A method for manufacturing a honeycomb structure according to claim 1, wherein a honeycomb dried article is manufactured by subjecting the honeycomb formed article to dielectric drying.

4. A method for manufacturing a honeycomb structure according to claim 2, wherein a honeycomb dried article is manufactured by subjecting the honeycomb formed article to dielectric drying.

5. A method for manufacturing a honeycomb structure according to claim 1, wherein the oxide ceramic-forming raw material is a cordierite-forming raw material.

6. A method for manufacturing a honeycomb structure according to claim 2, wherein the oxide ceramic-forming raw material is a cordierite-forming raw material.

7. A method for manufacturing a honeycomb structure according to claim 3, wherein the oxide ceramic-forming raw material is a cordierite-forming raw material.

8. A method for manufacturing a honeycomb structure according to claim 4, wherein the oxide ceramic-forming raw material is a cordierite-forming raw material.
